(19) United States
(12) Patent Application Publication
(10) Pub. No.: US 2006/0262215 A1
(43) Pub. Date: Nov. 23, 2006

(54) Auto-exposing method of a digital photographic apparatus

(76) Inventor: Mei-Chuan Wang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/131,396

(22) Filed: May 18, 2005

(51) Int. Cl. H04N 5/235

(52) U.S. Cl. 348/362

(57) ABSTRACT

The present invention relates to an auto-exposing method of a digital photographic apparatus. In particular, the auto-exposing method includes the controlling of weightings that can lead to change exposure tactics therefor; still, such an auto-exposing method is capable of calculating new exposure tactics by itself in order to obtain proper exposure based on the weightings when a user set more than one variable therein as manual conditions. Moreover, the traditional elaborate calculating can be substituted by list checking of the present invention; wherein the list is built according to characteristic curves of the sensitometer through forecasting functions. Accordingly, the anticipative results list of the present method will be more precise than that of the mathematic calculating method, the number of calculations thereof will be less and the calculating speed thereof will be faster.

### BACKGROUND OF THE INVENTION

1. Field of the invention

The present invention relates to an auto-exposing method of a digital photographic apparatus, which particularly can change exposure tactics by controlling weightings of exposure variables, so that more precise exposure variables, less calculation and faster computing speed can be achieved.

2. Related Prior Arts

To take clearer photographs, proper exposure of the digital photographic apparatus is usually reached by regulating iris. In addition to iris, ISO of the sensor and exposure time can be also used to control the digital photographic apparatus.

However, a lot of variables for controlling exposure, for example, iris, ISO and exposure time, might result in a complicated auto-exposing process and retard maintenance and commercialization thereof.

Therefore, it's desired to develop a proper auto-exposing process for solving the above problems.

### SUMMARY OF THE INVENTION

An object of the present invention is to provide an auto-exposing method of a digital photographic apparatus, in which exposure tactics can be changed with weightings.

Another object of the present invention is to provide an auto-exposing method of a digital photographic apparatus, in which proper exposure can be automatically completed through a new exposure tactics with weightings even though one or more variables are set manually.

A further object of the present invention is to provide an auto-exposing method of a digital photographic apparatus, by which more precise results, less calculation and faster computing speed can be obtained than by traditional mathematic calculating method.

In order to achieve the above objects, the auto-exposing method of the digital photographic apparatus in accordance with the present invention comprises steps of:

(A) building an anticipative results list according to characteristic curves of a digital photographic apparatus, and determining a predict EV step required for correcting brightness of a target image by referring to current brightness;

(B) building an exposure time list according to exposure values (abbreviated as EV) and defining weightings of each exposure time;

(C) building an ISO list according to exposure values and defining weightings of each ISO;

(D) building an iris list according to exposure values and defming weightings of each iris;

(E) selecting initial values from the exposure time list, the ISO list and the iris list, and calculating an exposure value;

(F) capturing an image by a sensor of the digital photographic apparatus, and calculating brightness of the image with the initial values by a computing system;

(G) finding a new predict EV step corresponding to the calculated brightness in the anticipative results list of step (A) for correcting brightness of the target image;

(H) judging whether the new predict EV step is convergent relative to the previous predict EV step?

if yes, the exposure value of step (E) is an optimal exposure value and terminating the process;

if no, continuing the following steps:

(I) adding the predict EV step to the previous exposure value to obtain a new exposure value;

(J) calculating one or more sets of exposure time, ISO and iris satisfying the new exposure value, and determining an optimal set according to weighting summations thereof, and inputting the optimal variables into the digital photographic apparatus, in which the manually-set variable is fix, if any;

(K) estimating brightness of the captured image according to the variables of step (J);

(L) repeating steps (G)˜(K) until the predict EV step is convergent and terminating the auto-exposing process.

To illustrate the present invention, the following embodiments accompanied with drawings are exemplified.

### BRIEF DESCRIPTION OF THE DRAWING

FIG. 1 shows the process for performing the present invention.

FIG. 2 shows the anticipative results list for the present invention.

FIG. 3 shows the exposure time list for the present invention.

FIG. 4 shows the ISO list for the present invention.

FIG. 5 shows the iris list for the present invention.

### DETAILED DESCRIPTION OF THE PREFERRED EMBODIMENTS

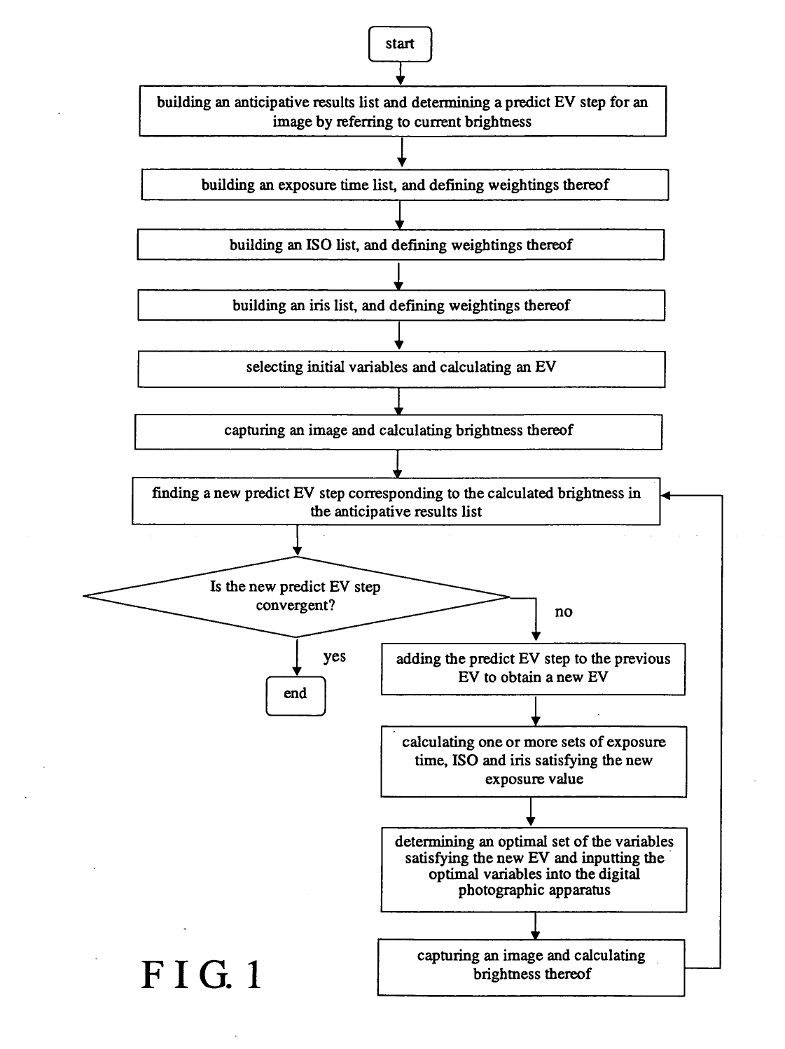

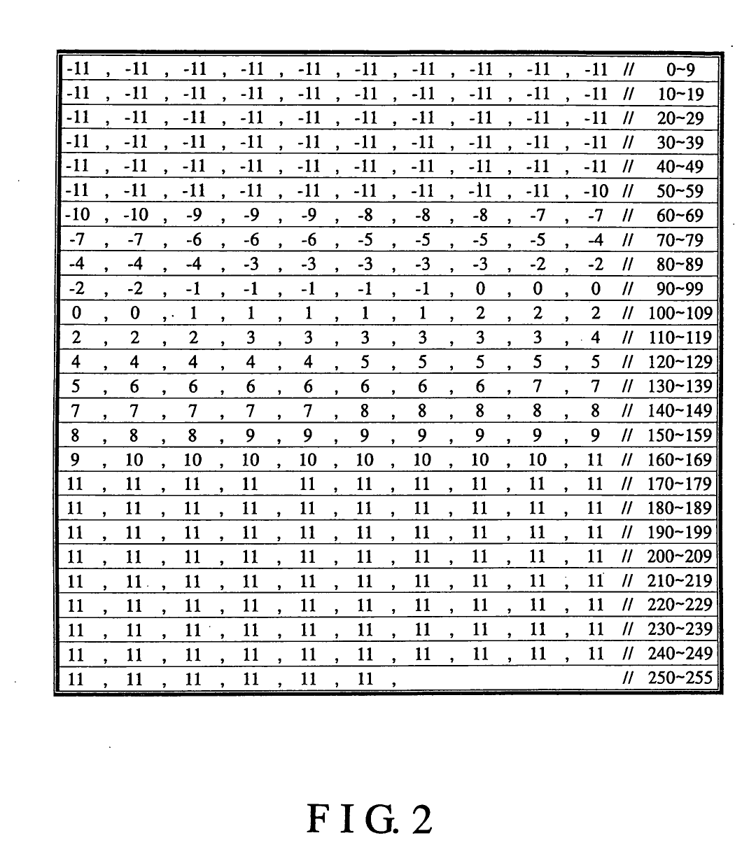

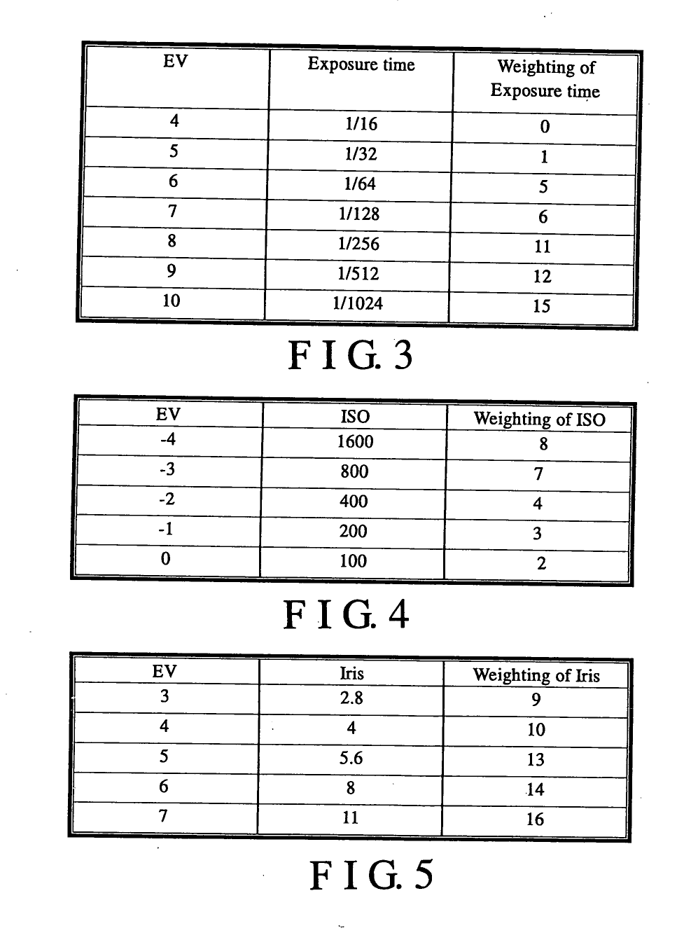

FIG. 1 shows the process of an auto-exposing of a digital photographic apparatus in accordance with the present invention and comprises steps of:

(A) building an anticipative results list according to characteristic curves of a digital photographic apparatus, and determining a predict EV step required for correcting brightness of a target image by referring to current brightness; for example, image brightness of a digital photographic apparatus ranges from 0 to 255, and an anticipative results list shown in Table 1 is built according to characteristics thereof; if the predict EV step required for correction in the anticipative results list is zero, the auto-exposing process is convergent, and therefore a convergent zone of brightness ranges between 97 and 101 can be found in Table 1;

TABLE 1

| Predict EV Step | | | | | | | | | | Brightness |
|---|---|---|---|---|---|---|---|---|---|---|
| −11 | −11 | −11 | −11 | −11 | −11 | −11 | −11 | −11 | −11 | 0˜9 |
| −11 | −11 | −11 | −11 | −11 | −11 | −11 | −11 | −11 | −11 | 10˜19 |
| −11 | −11 | −11 | −11 | −11 | −11 | −11 | −11 | −11 | −11 | 20˜29 |
| −11 | −11 | −11 | −11 | −11 | −11 | −11 | −11 | −11 | −11 | 30˜39 |
| −11 | −11 | −11 | −11 | −11 | −11 | −11 | −11 | −11 | −11 | 40˜49 |
| −11 | −11 | −11 | −11 | −11 | −11 | −11 | −11 | −11 | −10 | 50˜59 |
| −10 | −10 | −9 | −9 | −9 | −8 | −8 | −8 | −7 | −7 | 60˜69 |
| −7 | −7 | −6 | −6 | −6 | −5 | −5 | −5 | −5 | −4 | 70˜79 |
| −4 | −4 | −4 | −3 | −3 | −3 | −3 | −3 | −2 | −2 | 80˜89 |
| −2 | −2 | −1 | −1 | −1 | −1 | −1 | 0 | 0 | 0 | 90˜99 |
| 0 | 0 | 1 | 1 | 1 | 1 | 1 | 2 | 2 | 2 | 100˜109 |
| 2 | 2 | 2 | 3 | 3 | 3 | 3 | 3 | 3 | 4 | 110˜119 |
| 4 | 4 | 4 | 4 | 4 | 5 | 5 | 5 | 5 | 5 | 120˜129 |
| 5 | 6 | 6 | 6 | 6 | 6 | 6 | 6 | 7 | 7 | 130˜139 |
| 7 | 7 | 7 | 7 | 7 | 8 | 8 | 8 | 8 | 8 | 140˜149 |
| 8 | 8 | 8 | 9 | 9 | 9 | 9 | 9 | 9 | 9 | 150˜159 |
| 9 | 10 | 10 | 10 | 10 | 10 | 10 | 10 | 10 | 11 | 160˜169 |
| 11 | 11 | 11 | 11 | 11 | 11 | 11 | 11 | 11 | 11 | 170˜179 |
| 11 | 11 | 11 | 11 | 11 | 11 | 11 | 11 | 11 | 11 | 180˜189 |
| 11 | 11 | 11 | 11 | 11 | 11 | 11 | 11 | 11 | 11 | 190˜199 |
| 11 | 11 | 11 | 11 | 11 | 11 | 11 | 11 | 11 | 11 | 200˜209 |
| 11 | 11 | 11 | 11 | 11 | 11 | 11 | 11 | 11 | 11 | 210˜219 |
| 11 | 11 | 11 | 11 | 11 | 11 | 11 | 11 | 11 | 11 | 220˜229 |
| 11 | 11 | 11 | 11 | 11 | 11 | 11 | 11 | 11 | 11 | 230˜239 |
| 11 | 11 | 11 | 11 | 11 | 11 | 11 | 11 | 11 | 11 | 240˜249 |
| 11 | 11 | 11 | 11 | 11 | 11 | — | — | — | — | 250˜255 |

(B) building an exposure time list according to exposure values and defining weightings of each exposure time; and Table 2 shows an exposure time list built according to the above digital photographic apparatus; in which,
EV=−Log 2 (Exposure time);

TABLE 2

| | | weightings of |
|---|---|---|
| EV | Exposure time | exposure time |
| 4 | 1/16 | 0 |
| 5 | 1/32 | 1 |
| 6 | 1/64 | 5 |
| 7 | 1/128 | 6 |
| 8 | 1/256 | 11 |
| 9 | 1/512 | 12 |
| 10 | 1/1,024 | 15 |

(C) building an ISO list according to exposure values and defining weightings of each ISO; and Table 3 shows an ISO list built according to the above digital photographic apparatus; in which,
EV=−Log 2 (ISO/100);

TABLE 3

| EV | ISO | weightings of ISO |
|---|---|---|
| −4 | 1,600 | 8 |
| −3 | 800 | 7 |
| −2 | 400 | 4 |
| −1 | 200 | 3 |
| 0 | 100 | 2 |

(D) building an iris list according to exposure values and defining weightings of each iris; and Table 4 shows an iris list built according to the above digital photographic apparatus; in which,
EV=2×Log 2 (Iris);

TABLE 4

| EV | Iris | weightings of Iris |
|---|---|---|
| 3 | 2.8 | 9 |
| 4 | 4.0 | 10 |
| 5 | 5.6 | 13 |
| 6 | 8.0 | 14 |
| 7 | 11.0 | 16 |

(E) selecting initial values from the exposure time list, the ISO list and the iris list, and calculating an exposure value;

(F) capturing an image by a sensor of the digital photographic apparatus, and calculating brightness of the image with the initial values by a computing system;

(G) finding a new predict EV step corresponding to the calculated brightness in the anticipative results list of step (A) for correcting brightness of the target image;

(H) judging whether the new predict EV step is convergent relative to the previous predict EV step?

if yes, the exposure value of step (E) is an optimal exposure value and terminating the process;

if no, continuing the following steps:

(I) adding the predict EV step to the previous exposure value to obtain a new exposure value;

(J) calculating one or more sets of exposure time, ISO and iris satisfying the new exposure value, and determining an optimal set according to weighting summations thereof, and inputting the optimal variables into the digital photographic apparatus, in which the manually-set variable is fix, if any;

(K) estimating brightness of the captured image according to the variables of step (J);

(L) repeating steps (G)˜(K) until the predict EV step is convergent and terminating the auto-exposing process.

### EXAMPLE 1

Under the completely automatic mode, initial variables are set as follows:

initial EV=3, previous EV=3, Exposure time= 1/16, ISO=1600, Iris=2.8.

Then the initial Exposure time, ISO and Iris are input into the digital photographic apparatus. An image is captured by a sensor according to the initial variables and brightness of the image is estimated as 149 by a computing system thereof.

Referring to FIG. 1, predict EV step 8 corresponding to brightness 149 is found by list checking.

$$\begin{matrix}new EV = previous EV + predict EV step \\ = 3 + 8 = 11\end{matrix}$$

Table 5 indicates all variables and weightings in the exposure time list, the ISO list and the iris list of Tables 2˜4, which result in EV 11.

TABLE 5

| | | Weighting | | | | | |
|---|---|---|---|---|---|---|---|
| | Expo- | of | | Weight- | | Weight- | |
| | sure | Exposure | | ing of | | ing of | Weighting |
| EV | time | time | ISO | ISO | Iris | Iris | summation |
| 11 | 1/16 | 0 | 100 | 2 | 11 | 16 | 18 |
| 11 | 1/32 | 1 | 200 | 3 | 11 | 16 | 20 |
| 11 | 1/32 | 1 | 100 | 2 | 8 | 14 | 17 |
| | | | | | | | (minimum) |
| 11 | 1/64 | 5 | 400 | 4 | 11 | 16 | 25 |
| 11 | 1/64 | 5 | 200 | 3 | 8 | 14 | 22 |
| 11 | 1/64 | 5 | 100 | 2 | 5.6 | 13 | 20 |
| 11 | 1/128 | 6 | 800 | 7 | 11 | 16 | 29 |
| 11 | 1/128 | 6 | 400 | 4 | 8 | 14 | 24 |
| 11 | 1/128 | 6 | 200 | 3 | 5.6 | 13 | 22 |
| 11 | 1/128 | 6 | 100 | 2 | 4 | 10 | 18 |
| 11 | 1/256 | 11 | 1600 | 8 | 11 | 16 | 35 |
| 11 | 1/256 | 11 | 800 | 7 | 8 | 14 | 32 |
| 11 | 1/256 | 11 | 400 | 4 | 5.6 | 13 | 28 |
| 11 | 1/256 | 11 | 200 | 3 | 4 | 10 | 24 |
| 11 | 1/256 | 11 | 100 | 2 | 2.8 | 9 | 22 |
| 11 | 1/512 | 12 | 1600 | 8 | 8 | 14 | 34 |
| 11 | 1/512 | 12 | 800 | 7 | 5.6 | 13 | 32 |
| 11 | 1/512 | 12 | 400 | 4 | 4 | 10 | 26 |
| 11 | 1/512 | 12 | 200 | 3 | 2.8 | 9 | 24 |
| 11 | 1/1024 | 15 | 1600 | 8 | 5.6 | 13 | 36 |
| 11 | 1/1024 | 15 | 800 | 7 | 4 | 10 | 32 |
| 11 | 1/1024 | 15 | 400 | 4 | 2.8 | 9 | 28 |

Optimal variables are determined as weighting summation is the minimum. In this case, the optimal exposure time is 1/32, ISO is 100 and iris is 8 as weighting summation is 17 at EV is 11. Then the optimal variables are input into the digital photographic apparatus for estimating brightness of an image captured by a sensor of the apparatus. The brightness (Y) is estimated as 91.

Referring to the anticipative results list, predictive EV step-2 corresponding to brightness 91 is found by list checking.

$$\begin{matrix}new EV = previous EV + predict EV step \\ = 11 + ( - 2 ) = 9.\end{matrix}$$

Table 6 indicates all variables and weightings in the exposure time the ISO list and the iris list of Tables 2˜4, which result in EV 9.

TABLE 6

| | | Weighting | | | | | |
|---|---|---|---|---|---|---|---|
| | Expo- | of | | Weight- | | Weight- | |
| | sure | Exposure | | ing of | | ing of | Weighting |
| EV | time | time | ISO | ISO | Iris | Iris | summation |
| 9 | 1/16 | 0 | 400 | 4 | 11 | 16 | 20 |
| 9 | 1/16 | 0 | 200 | 3 | 8 | 14 | 17 |
| 9 | 1/16 | 0 | 100 | 2 | 5.6 | 13 | 15 |
| 9 | 1/32 | 1 | 800 | 7 | 11 | 16 | 24 |
| 9 | 1/32 | 1 | 800 | 4 | 8 | 14 | 19 |
| 9 | 1/32 | 1 | 200 | 3 | 5.6 | 13 | 17 |
| 9 | 1/32 | 1 | 100 | 2 | 4 | 10 | 13 |
| | | | | | | | (minimum) |
| 9 | 1/64 | 5 | 1600 | 8 | 11 | 16 | 29 |
| 9 | 1/64 | 5 | 800 | 7 | 8 | 14 | 26 |
| 9 | 1/64 | 5 | 800 | 4 | 5.6 | 13 | 22 |
| 9 | 1/64 | 5 | 200 | 3 | 4 | 10 | 18 |
| 9 | 1/64 | 5 | 100 | 2 | 2.8 | 9 | 16 |
| 9 | 1/128 | 6 | 1600 | 8 | 8 | 14 | 28 |
| 9 | 1/128 | 6 | 800 | 7 | 5.6 | 13 | 26 |
| 9 | 1/128 | 6 | 400 | 4 | 4 | 10 | 20 |
| 9 | 1/128 | 6 | 200 | 3 | 2.8 | 9 | 18 |
| 9 | 1/256 | 11 | 1600 | 8 | 5.6 | 13 | 32 |
| 9 | 1/256 | 11 | 800 | 7 | 4 | 10 | 28 |
| 9 | 1/256 | 11 | 400 | 4 | 2.8 | 9 | 24 |
| 9 | 1/512 | 12 | 1600 | 8 | 4 | 10 | 30 |
| 9 | 1/512 | 12 | 800 | 7 | 2.8 | 9 | 28 |
| 9 | 1/1024 | 15 | 1600 | 8 | 2.8 | 9 | 32 |

Optimal variables are determined as weighting summation is the minimum. In this case, the optimal exposure time is 1/32, ISO is 100 and iris is 4 as weight summation is 13 at EV is 9. Then the optimal variables are input into the digital photographic apparatus for estimating brightness of an image captured by a sensor of the apparatus. The brightness (Y) is estimated as 99.

Referring to the anticipative results list, predictive EV step 0 corresponding to brightness 99 is found by list checking. “Predictive EV step 0” indicates the auto-exposing process is convergent and terminated.

### EXAMPLE 2

Under the partially automatic mode, initial iris is manually set as 5.6, and other variables are set as follows:

initial EV=5, previous EV=5, Exposure time= 1/16, ISO=1600, iris=5.6.

Then the initial Exposure time, ISO and Iris are input into the digital photographic apparatus. An image is captured by a sensor according to the initial variables and brightness of the image is estimated as 134 by a computing system thereof.

Referring to FIG. 1, predict EV step 6 corresponding to brightness 134 is found by list checking.

$$\begin{matrix}new EV = previous EV + predict EV step \\ = 5 + 6 = 11\end{matrix}$$

Table 7 indicates all variables and weights in the exposure time list, the ISO list and the iris list of Tables 2˜4, which result in EV 11, wherein iris is fixed at 5.6.

TABLE 7

| | | Weighting | | | | | |
|---|---|---|---|---|---|---|---|
| | Expo- | of | | Weight- | | | |
| | sure | Exposure | | ing of | | Weighting | Weighting |
| EV | time | time | ISO | ISO | Iris | of Iris | summation |
| 11 | 1/64 | 5 | 100 | 2 | 5.6 | 13 | 20 |
| | | | | | | | (minimum) |
| 11 | 1/128 | 6 | 200 | 3 | 5.6 | 13 | 22 |
| 11 | 1/256 | 11 | 400 | 4 | 5.6 | 13 | 28 |
| 11 | 1/512 | 12 | 800 | 7 | 5.6 | 13 | 32 |
| 11 | 1/1024 | 15 | 1600 | 8 | 5.6 | 13 | 36 |

Optimal variables are determined as weighting summation is the minimum. In this case, the optimal exposure time is 1/64, ISO is 100 and iris is 5.6 as weighting summation is 20 at EV is 11. Then the optimal variables are input into the digital photographic apparatus for estimating brightness of an image captured by a sensor of the apparatus. The brightness (Y) is estimated as 105.

Referring to FIG. 1, predict EV step 1 corresponding to brightness 105 is found by list checking.

$$\begin{matrix}new EV = previous EV + predict EV step \\ = 11 + 1 = 12\end{matrix}$$

Table 8 indicates all variables and weights in the exposure time list, the ISO list and the iris list of Tables 2˜4, which result in EV 12, wherein iris is fixed at 5.6.

TABLE 8

| | | Weighting | | | | | |
|---|---|---|---|---|---|---|---|
| | Expo- | of | | Weight- | | | |
| | sure | Exposure | | ing of | | Weighting | Weighting |
| EV | time | time | ISO | ISO | Iris | of Iris | summation |
| 12 | 1/128 | 6 | 100 | 2 | 5.6 | 13 | 21 |
| | | | | | | | (minimum) |
| 12 | 1/256 | 11 | 200 | 3 | 5.6 | 13 | 27 |
| 12 | 1/512 | 12 | 400 | 4 | 5.6 | 13 | 29 |
| 12 | 1/1024 | 15 | 800 | 7 | 5.6 | 13 | 35 |

Optimal variables are determined as weighting summation is the minimum. In this case, the optimal exposure time is 1/128, ISO is 100 and iris is 5.6 as weight summation is 21 at EV is 12. Then the optimal variables are input into the digital photographic apparatus for estimating brightness of an image captured by a sensor of the apparatus. The brightness (Y) is estimated as 101.

Referring to FIG. 1, predict EV step 0 corresponding to brightness 101 is found by list checking. “Predictive EV step 0” indicates the auto-exposing process is convergent and terminated.

In the above embodiments, the anticipative results list, the exposure time list, the ISO list and the iris list are presented in the form of a list in array or programming codes.

In view of the preferred embodiments, the present invention exhibits advantages including:

1. High precision in the anticipative results list can be achieved as the list is built according to characteristics of the specific digital photographic apparatus.

2. Less numbers of calculations, faster calculating speed and lower power consumption can be obtained as list checking takes the place of traditional mathematic calculating method.

3. Exposure tactics can be automatically determined and easily changed according to weightings of the variables.

4. Exposure tactics can be still automatically determined according to weightings of the variables, even though one or more variables are manually fixed.

While the present invention has been illustrated by the preferred embodiments, the scope of the present invention shouldn't be limited but is referred to the claims.

What is claimed is:

1. An auto-exposing method of a digital photographic apparatus; comprising steps of:
(a) building an exposure time list, an ISO list and an iris list according to exposure characteristics of said digital photographic apparatus;
(b) calculating exposure values and weighting in each of said exposure time list, said ISO list and said iris list;
(c) selecting proper variables from each of said exposure time list, said ISO list and said iris list, and inputting these variables into said digital photographic apparatus;
(d) capturing an image and calculating brightness thereof by a computing system of said digital photographic apparatus;
(e) finding a predict EV step corresponding to said brightness in an anticipative results list, if said predict EV step is convergent, said exposure value is optimal.

2. The auto-exposing method as claimed in claim 1, if said predict EV step is divergent, steps (b)˜(e) are repeated until a new predict EV step is convergent.

3. The auto-exposing method as claimed in claim 1, wherein said exposure value and weighting in step (b) are determined by list checking.

4. The auto-exposing method as claimed in claim 1, wherein said exposure time list, said ISO list and said iris list are presented in the form of programming codes.

5. The auto-exposing method as claimed in claim 1, wherein said exposure time list, said ISO list and said iris list are presented in the form of a list in array.

6. The auto-exposing method as claimed in claim 1, wherein said forecasting function is performed by list checking, inputting brightness of said image and outputting predict EV step.
